(19) United States
(12) Patent Application Publication
(10) Pub. No.: US 2012/0191769 A1
(43) Pub. Date: Jul. 26, 2012

(54) SITE-AWARE DISTRIBUTED FILE SYSTEM ACCESS FROM OUTSIDE ENTERPRISE NETWORK

(75) Inventors: Dan Lovinger, Seattle, WA (US); Sharad Kylasam, Seattle, WA (US); Richa Kumar, Sammamish, WA (US); Jairo Cadena, Lake Stevens, WA (US); Mahesh Unnikrishnan, Redmond, WA (US); Manoj Kadam, Bellevue, WA (US); Ganesh Prasad, Bellevue, WA (US)

(73) Assignee: Microsoft Corporation, Redmond, WA (US)

(21) Appl. No.: 13/013,661

(22) Filed: Jan. 25, 2011

(51) Int. Cl. G06F 15/16

(52) U.S. Cl. 709/201

(57) ABSTRACT

Embodiments are directed to permitting client devices that connect remotely to an enterprise network to operate in a site-aware manner. In distributed file systems, files may be replicated in multiple places across a network. Embodiments are directed to providing requesting clients referrals (or paths) to replicas of desired information that are accessible by the requesting client with the least overall “cost” to the client and the network. The present systems and methods allow remote client devices to reliably identify a site with their referral requests so that the referring server(s) may provide site-aware referrals in response to the requests.

### BACKGROUND

Many corporations and other enterprises maintain networks, such as intranets, to facilitate management of information for the enterprise. Intranets may be distributed and include servers and devices in multiple geographic locations. Such locations may include local area networks to connect devices within the location and wide area networks to connect machines between locations. In addition, the global nature of modern commerce has made it more likely that enterprises must facilitate remote access to information stored on its intranet by employees and others working at home or while traveling. It is with respect to this general environment that the systems and methods provided herein are directed.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are configured to permit client devices that connect remotely to an enterprise network to operate in a site-aware manner. In embodiments, a remote client device connects to a first gateway server of an enterprise network. The client device receives a first site identifier, identifying the site to which the first gateway server belongs. The client device sends a first referral request for one or more referrals to a target object, and the referral request includes the site identifier of the gateway server. The client device receives an ordered set of one or more referrals to the target object and uses the referrals to access the object.

In another embodiment, a system is provided comprising a first gateway server, an object-referral server, and a plurality of storage servers. The first gateway server is operable to connect a remote client device to an enterprise network. The first gateway server sends the remote client device its site identifier, identifying the site to which the first gateway server belongs. The object-referral server is operable to provide referrals to requested object(s). The requested object(s) may be replicated and stored in the plurality of storage servers. When the object-referral server receives a request for referrals, the request includes the site identifier of the first gateway device. The object-referral server determines the cost of accessing the requested object(s) from one or more of the plurality of storage servers. The object-referral server orders the referrals to the requested object(s) according to the calculated costs, and sends the ordered referrals to the client device.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 illustrates an embodiment of a system for providing least-cost access to a requested object in accordance with the present disclosure.

FIG. 2 illustrates another embodiment of a system for providing least-cost access to a requested object in accordance with the present disclosure.

FIG. 3 illustrates an embodiment of a method for providing least-cost access to a requested object in accordance with the present disclosure.

FIG. 4 illustrates another embodiment of a method for providing least-cost access to a requested object in accordance with the present disclosure.

FIG. 5 illustrates an embodiment of a method for ordering referrals to a requested object according to a calculated cost of access related to such referrals.

FIG. 6 illustrates another embodiment of a method for ordering referrals to a requested object according to a calculated cost of access related to such referrals.

FIG. 7 illustrates an example computing environment that may be used with respect to the systems and methods of the present disclosure.

### DETAILED DESCRIPTION

The present systems and methods permit client devices that connect remotely to an enterprise network to operate in a site-aware manner. In distributed file systems in which files may be replicated in multiple places across a network, there is an advantage in providing requesting clients referrals (or paths) to replicas of desired information that are located closest to the requesting client (or are accessible by the requesting client with the least overall “cost” to the client and the network). For example, if a client is connected to a particular site and a replica of the file that the client wishes to access is located at that site, it is generally preferable to refer the client to the replica at that site rather than a different replica. Such site-aware referral, however, is made possible when the referring server is aware of the site from which the client request came. That information is not generally available if the client request is made in a “siteless” mode, wherein the request does not identify a site that is recognizable to the referring server. The present systems and methods allow remote client devices to reliably identify a site with their referral requests so that the referring server(s) may provide site-aware referrals in response to the requests.

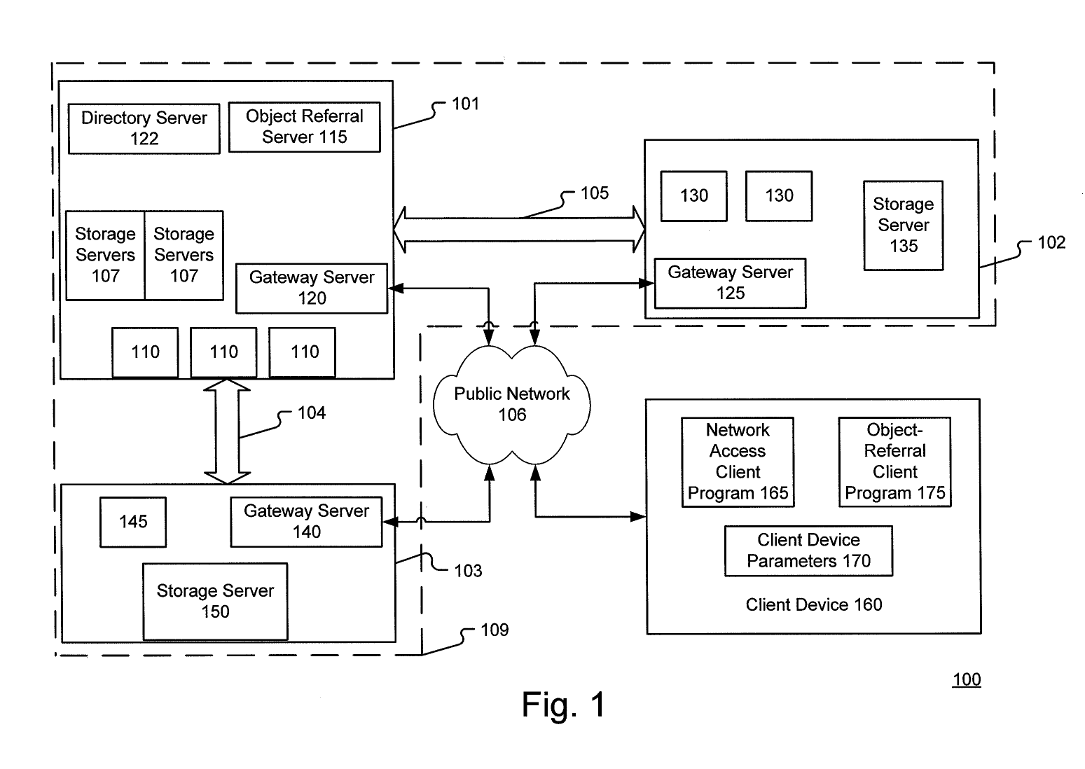

FIG. 1 describes an embodiment of a system 100 according to the present disclosure. In the embodiment shown, three sites 101, 102, and 103 are provided. In embodiments, a site may comprise one or more computing devices connected over a limited geographic area. For example, a local area network of computing devices connected via Ethernet or WiFi may be considered a site. In this example, site 101 is connected to both of sites 102 and 103 using wide area network (WAN) links 104 and 105. WAN links 104 and 105 may, in embodiments, comprise privately leased network connectivity between sites 101, 102, and 103. Generally speaking, bandwidth for WAN links 104 and 105 is more expensive to use and maintain than for the local area networks within sites 101, 102, and 103 or for use of a public network 106, such as the Internet. Together, the sites 101, 102, and 103 and WAN links 104 and 105 may comprise an example enterprise network 109 (depicted by dotted line in FIG. 1), such as an intranet for a corporation.

In FIG. 1, the sites 101, 102 and 103 are not identical. For example, site 101 may be a “home office” of an enterprise, such as a corporation. Sites 102 and 103 may be satellite offices of the enterprise. In the example embodiment shown, site 101 includes storage servers 107, locally connected client devices 110, object referral server 115, gateway server 120, and directory server 122, all of which are operatively connected to each other, for example, using a local area network within site 101.

Site 102 includes a gateway server 125, locally connected client devices 130, and a storage server 135, all of which are operatively connected to each other, for example, using a local area network within site 102. Similarly, site 103 includes a gateway server 140, locally connected client device 145, and a storage server 150, all of which are operatively connected to each other, for example, using a local area network within site 103.

In embodiments, storage servers 107, 135, and 150 store files, such as portals, intranet web sites, installable software, and other documents. Any such files may also be referred to herein as “objects.” In embodiments some of the files stored in one storage server may be replicated to one or more other storage servers, such as by using the distributed file system replication service (DFSR) available from Microsoft Corporation of Redmond, Wash. In embodiments, certain files are replicated so that locally connected clients 110, 130, and 145 at each of the sites 101, 102, and 103 can access a local copy of a file. Replication of files in more than one of storage servers 107, 135, and 150 permits easier access by locally connected client devices 110, 130, and 145, with less latency and limited use of the WAN links 104 and 105.

In embodiments, a locally connected client device, such as locally connected client device 145, accesses a replicated file as follows. In this example, enterprise network 109 includes a single object-referral server 115, located in site 101. The object-referral server 115 provides referrals to objects (such as files stored in storage servers 107, 135, and 150) to clients, such as client device 145. A single object-referral server 115 is shown in FIG. 1 for ease of illustration. In embodiments, additional object referral servers may be provided within enterprise network 109. For example, the contents of object referral server 115 may be replicated in a server located at site 102. When client device 145 makes a referral request for a file, the object-referral server 115 first determines the site 103 to which the client device 145 belongs. In embodiments, the referral request made by client device 145 includes the IP address of client device 145. In embodiments, the referral request made by client device 145 may also include the subnet mask of client device 145. Object-referral server 115 provides that information to directory server 122, which determines that the client device 145 is part of site 103 and provides that information back to object-referral server 115. In embodiments, directory server 122 may comprise an ACTIVE DIRECTORY® server (or domain controller (DC)) available from Microsoft Corporation of Redmond, Wash. Object-referral server 115 then provides a set of referrals for the requested file back to client device 145. The referrals may comprise paths to replicas of the requested file that are stored in one or more of the storage servers 107, 135, and 150.

In embodiments, the referrals returned to client device 145 are ordered in least-cost manner such that the first referral returned is a path to a replica of the file in storage server 150, which is in the same site 103 as client device 145. In embodiments, the requested file may not be replicated in all storage servers and may not be present in storage server 150. Accordingly, object-referral server 115 may order the referrals returned according to the “next-best” option for client device 145 to access the requested file. For example, if the requested file is present in storage servers 107 and in storage server 135, but not in storage server 150, the object-referral server 115 may return a referral to the storage location of the requested file within storage servers 107 first and within storage server 135 second because only one WAN link 104 is required to for client device 145 to access storage server 107 versus two WAN links 104 and 105 to access storage server 135.

In this example, directory server 122 is able to determine the site 103 of client device 145 because the IP address of client device 145 was assigned by enterprise network 109 when the client 145 signed on via local connection to site 103. In embodiments, this is not true for clients that connect remotely from outside of enterprise network 109. For example, a client that connects remotely from outside of enterprise network 109 through a gateway server, such as gateway server 125, will generally have an IP address assigned by its Internet service provider (ISP). The IP address provided by an ISP will generally not be recognizable to a directory server, such as directory server 122. Without the ability to determine reliably the site from which a client is connecting, an object-referral server, such as object-referral server 115, could not intelligently provide referrals to replicated files that are ordered in a way to achieve least-cost access to the file.

The present disclosure, however, provides a system and method for a remotely connected client to receive site-aware referrals to replicated files. For example, with reference again to FIG. 1, a client device 160 is remotely connected to enterprise network 109 through gateway server 125. Gateway server 125 (and gateway servers 107 and 140) may comprise servers that permit remote clients, such as client 160, to connect to enterprise network 109 over a public network 106, such as the Internet. In embodiments, gateway server 125 comprises a DIRECTACCESS® server available from Microsoft Corporation or Redmond Wash. Client device 160 may connect securely to gateway server 125, for example, using IPv6 and IPSec protocols. In embodiments, after mutual authentication and NAP (Network Access Protection) checks are complete, IPsec tunnels are established between client device 160 and the gateway server 125. In embodiments, client device 160 initially connects to the gateway server that is closest geographically to client device 160.

For example, assume that a user of client device 160 is a member of the home office of an enterprise, which is represented by site 101 in FIG. 1. The user typically connects locally to site 101 when in the home office. Assume for this example that site 101 is in New York City, N.Y., USA. However, the user is travelling with client device 160 in Europe. Site 102 is in London, England and the client device 160 is currently with the user in a hotel in Berlin, Germany. When the user logs onto client device 160, client device 160 connects to enterprise network 109 through the closest gateway server, which in this case is gateway server 125 in site 102. Discovery and connection to the closest gateway server can be performed in a variety of known manners. For example, the client device 160 may ping a list of known IP addresses for gateway servers and connect to the gateway server that provides the first response back to the client device 160. In embodiments, the client device 160 may also sort the list of known IP addresses for gateway servers using an IPv6 sorting algorithm.

Upon connecting to gateway server 125, the client device 160 receives from gateway server 125 a site identifier for gateway server 125. In other embodiments, the client device 160 may receive the site identifier for the gateway server 125 prior to connecting to gateway server 125. For example, client device 160 may be pre-provisioned with the site identifiers of all gateway servers 120, 125, and 140 in enterprise network 109. The client device 160 can then obtain the site identifier for gateway server 125 to which it is connected from local storage or another accessible storage location. The site identifier may comprise, for example, the IP address (with or without the subnet mask) of gateway server 125, which has been assigned by enterprise network 109. In other embodiments, the site identifier may comprise a resolved site name for site 102, such as “London.”

In embodiments, a network access client program 165, running on client device 160, receives the site identifier during an exchange of messages to negotiate the connection to enterprise network 109. As discussed above, in other embodiments, the site identifier for gateway 125 is already known to client device 160, and the network access client program 165 obtains the site identifier from local storage on client device 160 or from another accessible storage location. Once the site identifier is obtained for gateway 125, the network access client program 165 writes the site identifier into the client device parameters 170. In embodiments, client device parameters 170 may comprise a file or other storage mechanism for configuration and operating system parameters for client device 160. In embodiments where the client device 165 is running the Microsoft WINDOWS® operating system, available from Microsoft Corporation of Redmond, Wash., the client device parameters 170 may comprise registry keys. In that example, the site identifier is written into the “site name” registry key that is maintained by NetLogon.

In embodiments, the change to the client device parameters 170 causes a notification to be sent to object-referral client program 175 running on client device 160. Object-referral client program 175 reads the site identifier out of the client device parameters 170 and uses the site identifier in future requests for object referrals within enterprise network 109. In effect, client device 160 adopts the site 102 from gateway server 125 to which it is connected.

Object-referral client program 175 of client device 160, continuing the above example, sends a request for site-aware referrals to a target file, replicas' of which are stored on both storage servers 107 and storage server 135. The request for referrals is sent through gateway server 125 and WAN link 105 to object-referral server 115. The request includes an explicit declaration of the site identifier obtained from gateway server 125. If the site identifier is a fully resolved site name (e.g., “London”), the object-referral server 115 need not contact directory server 122 to determine the site of client 160. If the site identifier is unresolved, such as the IP address of gateway device 125, object-referral server 115 determines the site of client 160 by sending the site identifier to the directory server 122, which returns the resolved site name.

In either event, the object-referral server 115 generates a list of one or more referrals to the requested target file. In this example, the target file includes replicas on both storage server 107 and storage server 135. Because the client device 160 has provided a site identifier in the referral request, the object-referral server determines the least-cost referral to the target file from the site identified by the site identifier (in this example, site 102). Accordingly, because the target file is available on storage server 135, which is within site 102, the object-referral server 115 will likely determine that the least-cost access to the target file is via the replica stored on storage server 135. Accordingly, the object-referral server 115 orders the referral to the replica on storage server 135 first in the list of referrals sent back to client device 160. The object-referral server 115 may also, in embodiments, return a referral to the replica of the target file on storage servers 107, in case the storage server 135 is unavailable or inoperable. The referral to the replica of the target file on storage servers 107, in this example, would be ordered after the referral to the replica on storage server 135. As discussed, in embodiments, referrals provided by object-referral server 115 to client device 160 may comprise file-system paths to respective replicas of the target file(s).

In embodiments, the object-referral server 115 may make least-cost access determinations based on a variety of factors. For example, least-cost access determinations can be made based on geographic distance between the site provided in a referral request and the nearest storage server containing a target file replica. In other embodiments, least-cost access determinations may be made based on the cost of the communication links required to be traversed in order for client device 160 to access a target file replica. For example, in embodiments, a client device 160 may be disconnected from a gateway server, such as gateway server 125, and reconnected to a different gateway server, such as gateway server 140, in order to access a replica stored on storage server 150 at site 103.

In embodiments, the system described in FIG. 1 permits client devices to connect, disconnect, and reconnect to and from a variety of different access points for enterprise network 109. For example, a client device 160 may first be connected as a locally connected device at site 101 while an employee is working in the main office. The employee may then leave for the day and take client device home where, when the employee logs on again, the client device 160 connects to gateway device 120. Client device 160 then obtains the site identifier of gateway server 120, for example from the gateway server 120 or from local storage or another accessible storage location. Referral requests while the client device 160 is connected use the site identifier of gateway server 120 in the manner discussed above to receive referrals to requested objects that are optimized for a client located at site 101. Continuing with the above example, assume the employee puts her client device in hibernation mode and then travels to Europe and works from her hotel room. The client device 160, upon being taken out of hibernation mode, discovers that it is closer to gateway server 125. Accordingly, the client device 160 establishes a new connection with gateway server 125 and obtains the site identifier for gateway server 125, e.g., from gateway server 125 or from local storage or another accessible storage location. Subsequent requests for object referrals, then, will use the site identifier of gateway server 125 so that the referrals received are optimized for a client connected to site 102. In embodiments, each time a new site identifier is received (e.g., when the client device is taken out of hibernation mode and reconnected to gateway server 125), the network access client program 165 overwrites the previously set site identifier in client device parameters 170 with the new site identifier. In addition, in embodiments, the object-referral client program 175 is alerted each time a change to the site identifier stored in client device parameters 170 is made.

The file replication and referrals disclosed in this application may be accomplished, in embodiments, using the Distributed File System (DFS) service provided by Microsoft Corporation of Redmond, Wash. DFS employs several relevant protocols for performing replication and referrals to replicated files. For example, file replication can be accomplished using the Distributed File System Replication Protocol Specification (MS-FRS2) available from Microsoft Corporation. In addition, the Distributed File System (DFS) Referral Protocol Specification (DFS Referral) available from Microsoft Corporation of Redmond, Wash. enables file system clients to access remote file shares by using a DFS path (or virtual name) for the share, which is then transparently resolved to an actual share name on an actual file server. For example, DFS can enable the grouping of a set of shares located on different file servers (such as storage servers 107, 135, and 150) into a unified namespace. Without DFS, users of a network file system, such as Server Message Block (SMB) and Server Message Block version 2 (SMB2), are required to know the names of all file servers, and files that reside on those file servers, for which they require access. With DFS Referral, users can navigate a unified namespace to access files and folders without knowledge of the names of individual file servers and shares that host the data.

DFS Referral supports two types of namespaces: domain-based namespaces, which offer high availability and load balancing, and stand-alone namespaces, which reside on a single DFS root target server and do not require domain infrastructure. In stand-alone DFS namespaces, clients issue root referral requests and link referral requests directly to the DFS root target server. The embodiment described with respect to FIG. 1 could be created using a stand-alone DFS namespace. For example, object-referral client program 175 may comprise a DFS client application and object-referral server 115 may comprise a stand-alone DFS namespace server that issues referrals for all replicated files in the enterprise network 109 located on file servers (such as storage servers 107, 135, and 150). In the example of FIG. 1, the object-referral server 115 provides referrals to target files in all of the storage servers 107, 135, and 150, which are part of a single namespace.

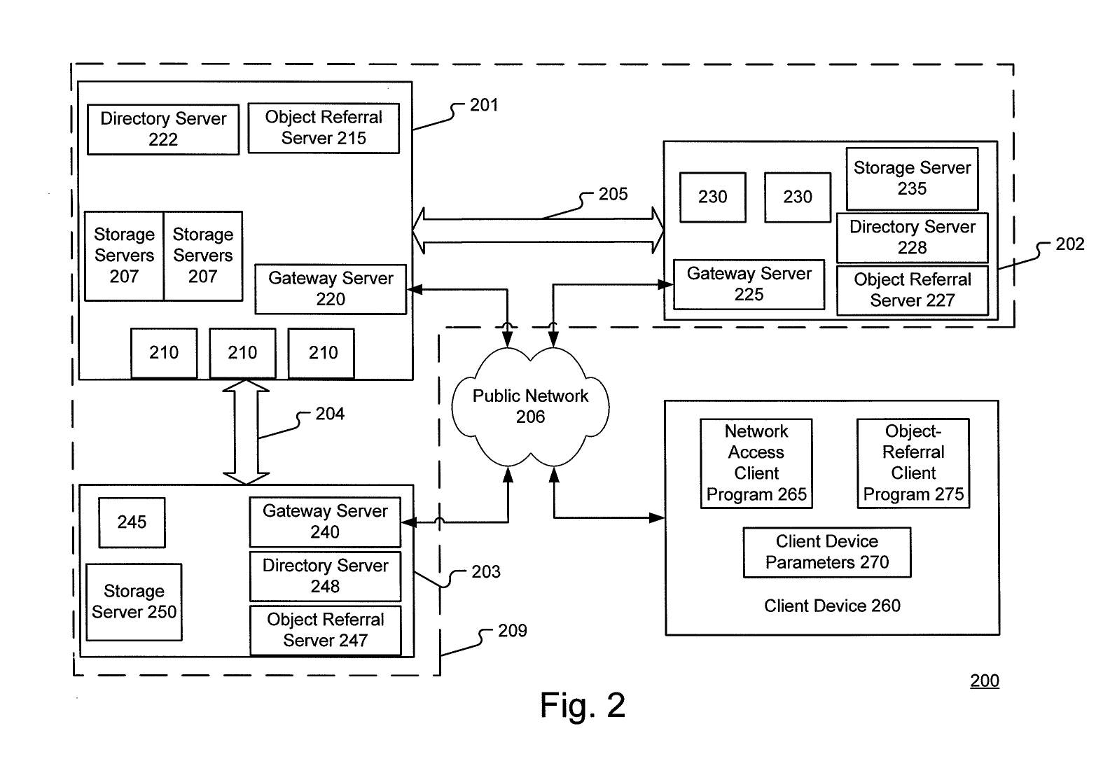

FIG. 2 illustrates an embodiment that is similar to the embodiment shown in FIG. 1, but in which multiple object-referral servers 215, 227, and 247 are employed. In this embodiment, each of sites 201, 202 and 203 has its own directory server 222, 228 and 248, respectively. Directory servers 222, 228 and 248 may comprise, in this example embodiment, locators for object-referral servers 215, 227, and 247.

In this example, site 201 is connected to both of sites 202 and 203 using WAN links 204 and 205. Together, the sites 201, 202, and 203 and WAN links 204 and 205 may comprise an example enterprise network 209, such as an intranet for a corporation. Similar to FIG. 1, the sites 201, 202 and 203 of FIG. 2 are not identical, and each may comprise a separate namespace. For example, site 201 may be a “home office” of an enterprise, such as a corporation. Sites 202 and 203 may be satellite offices of the enterprise. In the example embodiment shown, site 201 includes storage servers 207, locally connected client devices 210, object-referral server 215, gateway server 220, and directory server 222, all of which are operatively connected to each other, for example, using a local area network within site 201.

Site 202 includes a gateway server 225, locally connected client devices 230, object-referral server 227, directory server 228, and a storage server 235, all of which are operatively connected to each other, for example, using a local area network within site 202. Similarly, site 203 includes a gateway server 240, locally connected client device 245, object-referral server 247, directory server 248, and a storage server 250, all of which are operatively connected to each other, for example, using a local area network within site 203.

In embodiments, storage servers 207, 235, and 250 store files, such as portals, intranet web sites, installable software, and other documents. Any such files may also be referred to herein as “objects.” In addition, as discussed further herein, object-referral servers 215, 227, and 247 may also be considered “objects” to which referrals are made. In embodiments some of the files stored in one storage server may be replicated to one or more other storage servers, such as by using DFSR. In embodiments, certain files are replicated so that locally connected clients 210, 230, and 245 at each of the sites 201, 202, and 203 can access a local copy of a file.

The present disclosure provides a system and method for a remotely connected client to receive site-aware referrals to replicated files in a distributed file system with multiple object-referral servers and directory servers. For example, with reference again to FIG. 2, a client device 260 is remotely connected to enterprise network 209 through gateway server 225. Gateway server 225 (and gateway servers 207 and 240) may comprise servers that permit remote clients, such as client 260, to connect to enterprise network 209 over a public network 206, such as the Internet. In embodiments, gateway server 225 comprises a DIRECTACCESS server. Client device 260 may connect securely to gateway server 225, for example, using IPv6 protocols. After mutual authentication and NAP checks are complete, IPsec tunnels are established between client device 260 and the gateway server 225. In embodiments, client device 260 initially connects to the gateway server that is closest geographically to client device 260.

For example, assume again that a user of client device 260 is a member of the home office of an enterprise, which is represented by site 201 in FIG. 2. The user typically connects locally to site 201 when in the home office. Assume for this example that site 201 is in New York City, N.Y., USA. However, the user is travelling with client device 260 in Europe. Site 202 is in London, England and the client device 260 is currently with the user in a hotel in Berlin, Germany. When the user logs onto client device 260, client device 260 connects to enterprise network 209 through the closest gateway server, which in this case is gateway server 225 in site 202.

Upon connecting to gateway server 225, the client device 260 receives from gateway server 225 a site identifier for gateway server 225. In embodiments, the client device 260 may receive the site identifier for the gateway server 225 prior to connecting to gateway server 225. For example, client device 260 may be pre-provisioned with the site identifiers of all gateway servers 220, 225, and 240 in enterprise network 209. The site identifier may comprise, for example, the IP address and (with or without subnet mask) of gateway server 225, which has been assigned by enterprise network 209. In other embodiments, the site identifier may comprise a resolved site name for site 202, such as “London.”

In embodiments, a network access client program 265, running on client device 260, receives the site identifier during an exchange of messages to negotiate the connection to enterprise network 209. As discussed above, in other embodiments, the site identifier for gateway 225 is already known to client device 260, and the network access client program 265 obtains the site identifier from local storage on client device 260 or from another accessible storage location. Once the site identifier is obtained from gateway 225, the network access client program 265 writes the site identifier into the client device parameters 270. In embodiments, the change to the client device parameters 270 causes a notification to be sent to object-referral client program 275 running on client device 260. Object-referral client program 275 reads the site identifier out of the client device parameters 270 and uses the site identifier in future requests for object referrals within enterprise network 209. In effect, client device 260 adopts the site 202 from gateway server 225 to which it is connected.

Client device 260 next attempts to access a target file, replicas of which exist on both storage servers 235 and 207. Object-referral client program 275 of client device 260, continuing the above example, sends a request to a domain name system (DNS) server (not shown) for a list of directory servers that are appropriate for the namespace of the target file. In this example, object-referral program 275 receives an address for directory server 228. Object-referral client program 275 sends a referral request to directory server 228 for the least-cost access to an object-referral server. The referral request includes an explicit declaration of the obtained site identifier for gateway server 225. Directory server 228 may return an ordered list of object-referral servers based on least-cost access to such object-referral servers. In this example, directory server 228 returns an ordered list of referrals to object-referral servers, including a referral to object-referral server 227 at site 202. In embodiments, directory servers, such directory server 228, act as object-referral servers to provide referrals to objects, such as object-referral server 227.

Object-referral client program 275 then requests referrals for a particular file from object-referral server 227. The referral request includes the site identifier received from gateway server 225. The object-referral server 227 generates a list of one or more referrals to the requested target file. In this example, the target file includes replicas on both storage server 207 and storage server 235. Because the client device 260 has provided a site identifier in the referral request, the object-referral server determines the least-cost referral to the target file from the site identified by the site identifier (in this example, site 202). Accordingly, because the target file is available on storage server 235, which is within site 202, the object-referral server 227 may determine that the least-cost access to the target file is via the replica stored on storage server 235. Accordingly, the object-referral server 227 orders the referral to the replica on storage server 235 first in the list of referrals sent back to client device 260. The object-referral server 227 may also, in embodiments, return a referral to the replica of the target file on storage servers 207, in case the storage server 235 is unavailable or inoperable. The referral to the replica of the target file on storage servers 207, in this example, would be ordered after the referral to the replica on storage server 235. As discussed, in embodiments, referrals provided by object-referral server 227 to client device 260 may comprise file-system paths to respective replicas of the target file(s).

In embodiments, the object-referral server 227 may make least-cost access determinations based on a variety of factors. For example, least-cost access determinations can be made based on geographic distance between the site provided in a referral request and the nearest storage server containing a target file replica. In other embodiments, least-cost access determinations may be made based on the cost of the communication links required to be traversed in order for client device 260 to access a target file replica. For example, in embodiments, a client device 260 may be disconnected from a gateway server, such as gateway server 225, and reconnected to a different gateway server, such as gateway server 220, in order to access a replica stored on storage server 207 at site 201.

For embodiments employing domain-based namespaces using the WINDOWS operating system and DFS Referral, clients (such as client 260) issue DFS Referral requests to domain controllers (DCs) (such as directory server 228) to discover the existence of domains and the existence of DFS namespaces. Clients issue referral requests to DCs in order to discover the DFS root target servers (such as object-referral server 227) hosting specific DFS namespaces. Clients can also issue referral requests to DFS root target servers to discover other DFS root target servers (such as object-referral server 215) that host a DFS namespace. Clients issue referral requests to DFS root target servers to discover the locations of DFS link targets, such as files on file servers (such as storage servers 207, 235, and 250). After the components of a DFS path have been resolved to specific targets, clients then issue file system requests directly to file servers, using the appropriate remote file system protocol for that server.

In embodiments described in FIGS. 1 and 2, the underlying transport protocol used for referral requests may comprise an application-layer network protocol. For example, in embodiments using DFS Referral, the Server Message Block (SMB) Protocol, or the Server Message Block Version 2 (SMB2) Protocol may be used as a transport layer. DFS Referral allows SMB and SMB2 file system clients to resolve names from a namespace distributed across many servers and geographies into local names on specific file servers. After names have been resolved, clients can directly access files on the identified servers by using file system protocols, such as the SMB Protocol, the SMB Version 2.0 Protocol and NFS protocols.

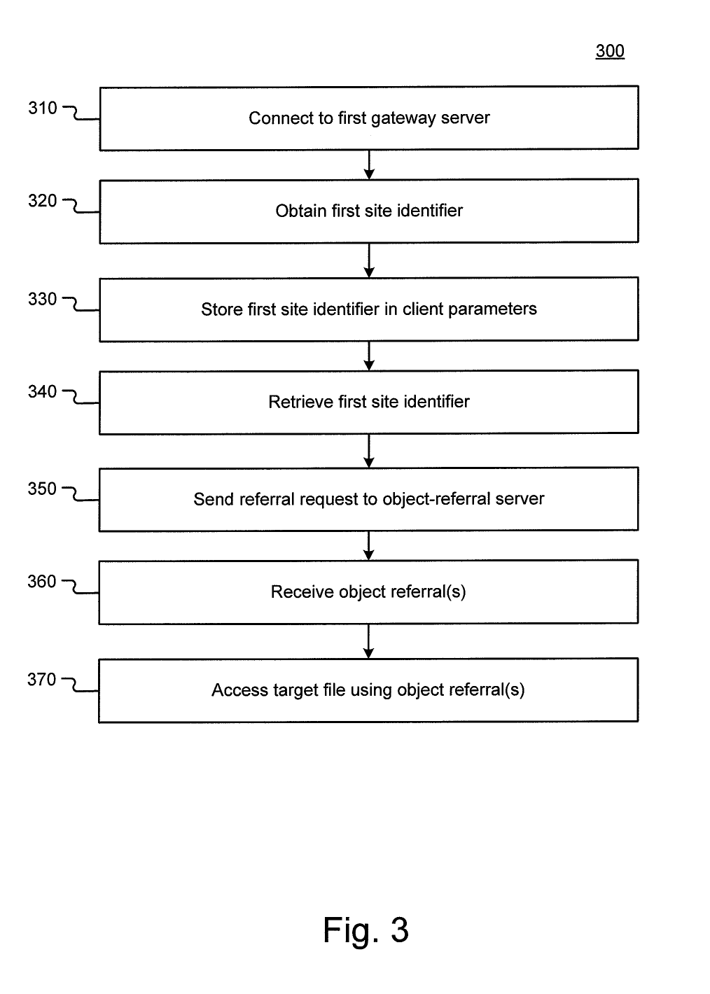

FIG. 3 illustrates a method 300 for obtaining least-cost access to a file located on a distributed file system, such as the system described with respect to FIG. 1. As should be appreciated, the particular steps and methods described for any methods herein are not exclusive and, as will be understood by those skilled in the art, the particular ordering of steps as described herein is not intended to limit the method, e.g., steps may be performed in differing order, additional steps may be performed, and disclosed steps may be excluded without departing from the spirit of the present disclosure.

Method 300 begins by connecting 310 a remote client, such as client device 160, to a first gateway server, such as gateway server 125. In embodiments, this is accomplished using a network access client program, such as network access client program 165, installed on a client device. The method 300 continues to step 320, wherein a first site identifier is obtained. In embodiments, a client device may receive the site identifier for the gateway server after connection to the gateway server. In other embodiments, the site identifier for the gateway server may be received and stored locally at the client device prior to connecting to gateway server and may obtained by retrieving the site identifier from local storage or another accessible storage location. For example, client device may be pre-provisioned with the site identifiers of all gateway servers in an enterprise network. In embodiments, the site identifier received may comprise an IP address (with or without a subnet mask) for the gateway server. In other embodiments, the site identifier may comprise a fully resolved site name.

The method 300 continues to step 330, wherein the first site identifier is stored in client parameters of the client device. For example, in embodiments in which the client is using a Microsoft WINDOWS operating system, step 330 may comprise setting a registry key of the client device. For example, the site identifier may be persisted in the SiteName registry key maintained by Netlogon. Details of this registry key are given below:

Key name: SiteName

Path: HKLM\SYSTEM\CurrentControlSet\Services\Netlogon\Parameters

This registry key may determine the site in which a client device asserts it is located. The network access client program populates the SiteName registry key maintained by Netlogon once it receives the site name from the gateway server. In addition, in embodiments, setting the SiteName registry key may cause the object-referral client program on the client device to be alerted that a remote network connection has been established. In other embodiments, the object-referral client program may register with a network list manager infrastructure and check site connectivity flags to determine that the client device is connected remotely to a network.

When the client device is disconnected from the gateway, the site identifier may be deleted from the client parameters and/or connectivity flags may be reset to inform the object-referral client program that the client device no longer belongs to the site of the gateway server. In addition, if the client device is disconnected from a gateway server and reconnected to another gateway server, the site identifier of the new gateway server may be inserted into the client parameters to alert the object-referral client program of the new site to which the client device is remotely connected. Alternatively, the object-referral client program may register with an application programming interface (API) on the client device to receive notifications each time the site identifier stored in the client parameters is changed or when the status of remote connectivity by the client device changes. For example, any of the following situations may cause a change in the site of client device that is reflected in the site name stored in client parameters: (a) client device connects to gateway server after being connected to the local area network (LAN) of a site (e.g., an employee travelling abroad who hibernated her laptop when connected to the LAN of a site and then resumed it and connected to a gateway server in another site); (b) client device rejoins the enterprise network after connecting from the gateway server for a period of time (e.g., an employee travelling abroad who works remotely from a hotel room, hibernates the laptop and then resumes the laptop when connected directly to the LAN of a site); or (c) client device connects to another gateway server and site (e.g., an employee travelling near different sites (e.g., the laptop is hibernated when the employee connected from home to the local gateway server and the laptop was thereafter resumed and connected to another gateway server in a different site).

At step 340, the site identifier is retrieved. In embodiments, this may comprise an object-referral client program retrieving the site identifier from client parameters stored on the client device. For example, in order to make a site-aware referral request, the object-referral client program may call a directory service application programming interface (API) that returns the current site to which the client device is connected. In embodiments, such API may be typically configured to determine the site dynamically; however, when a site identifier has been explicitly set in the client parameters (such as in step 330), the value of the explicitly set client parameter may override the dynamically determined site.

At step 350 a site-aware referral request is sent to an object-referral server. The referral request includes the site identifier retrieved at step 340. In embodiments, the referral request includes a target object or file to which access is sought. As a nonexclusive example, the following describes one potential referral request with reference to DFS Referral.

The DFS Referral protocol provides a defined message, REQ_GETDFS_REFERRAL, to make referral requests. This REQ_GET_DF S_REFERRAL message is a payload that travels over the SMB_COM_TRANSACTION2 message and the FSCTL_DFS_GET_REFERRALS IOCTL, when SMB and SMB2 are used as the transport protocol respectively. However, the REQ_GET_DFS_REFERRAL message does not provide a way for the client computer to send its site name across to the object-referral server, in order to receive site-aware referrals.

Therefore, a new type of referral request message called REQ_GET_DFS_REFERRAL_EX may be used to enable a remotely connected client device (such as client device 160) to send the site name obtained from a gateway server across to the object-referral server, in addition to the target file path to which it is requesting referrals. This message may be a payload over a new FSCTL_DFS_GET_REFERRALS_EX IOCTL that will be added to SMB2 as discussed below. The message and packet format of the site-aware referral request, referred to in this example as REQ_GET_DFS_REFERRAL_EX, and its response are specified below. For example, a possible message format for a site-aware referral request includes:

| | |
|---|---|
| 0 1 2 3 4 5 6 7 8 9 10 1 2 3 4 5 | 6 7 8 9 20 1 2 3 4 5 6 7 8 9 30 1 |
| MaxReferralLevel | RequestFlags |

RequestDataLength
RequestData (variable, length determined by value of RequestDataLength field)

In the example message format described above, MaxReferralLevel comprises a 16-bit integer that indicates the highest DFS Referral version understood by the client device. RequestFlags comprises a 16-bit field representing a series of flags. Each of the bits in the flags is set in order to indicate the presence of a field in the request buffer that follows. In this example, only the SiteName bit is defined and used. The ‘SiteName’ bit is be set to 1 if the packet contains the site identifier of the client device requesting referrals. RequestDataLength comprises a 32-bit integer that specifies the length of the data accompanying the referral request. The format of the data accompanying the referral request (RequestData) is interpreted according to the bits sets in the RequestFlags field. RequestData comprises a buffer of length RequestDataLength, and contains information specific to the referral being requested from the DFS Namespace server.

In nonexclusive embodiments, RequestData portion of a REQ_GET_DFS_REFERRAL_EX referral request may comprise:

0 1 2 3 4 5 6 7 8 9 10 1 2 3 4 5 6 7 8 9 20 1 2 3 4 5 6 7 8 9 30 1
RequestFileNameLength
RequestFileName ... (variable, length determined by value of RequestFileNameLength field)
SiteNameLength
SiteName ... (variable, length determined by value of SiteNameLength field)

In this example, RequestFileNameLength comprises 16-bit integer value that specifies the length of the RequestFileName string in the referral request. RequestFileName may comprise a null terminated UNICODE string specifying the path to be resolved. The order of fields is implementation specific, and, in embodiments, the format may depend on the type of referral request being made by the client device:
Domain referral: The path may be an empty string (containing just the null terminator). A client may use DFS referral version 3 or later for a domain referral request.
Directory server referral: The path may be “\<domain>” or “<domain>”, where <domain> is a domain name that may be in either NetBIOS or fully qualified domain name forms. The format of the response path may match the format of the request path. For example, if the request path is in NetBIOS form, the response path may also be in NetBIOS form. A client may use DFS referral version 3 or later for a domain controller referral request.
Sysvol referral: The path may be either “\<domain>\SYSVOL” or “\<domain>\NETLOGON”, where <domain> is a domain name that may be in either NetBIOS or fully qualified domain name forms. The format of the response path may match the format of the request path. For example, if the request path is in NetBIOS form, the response path may also be in NetBIOS form. A client may use DFS referral version 3 or later for a sysvol referral request.
Root referral: The path may be either of the form “\<domain>\<dfsname>” or the form “\<server>\<dfsname>”, where <domain> is the name of the domain that hosts the DFS namespace, <dfsname> is the name of a DFS namespace, and <server> is a DFS root target host name. NetBIOS and fully qualified domain names may be supported.
Link referral: The path may be either of the form “\<domain>\<dfsname>\<linkpath>” or the form “\<server>\<dfsname>\<linkpath>”, where <domain> is the name of the domain that hosts the DFS namespace, <dfsname> is the name of a DFS namespace, <server> is a DFS root target host name, <linkpath> is a path that may have a DFS link. NetBIOS and fully qualified domain names may be supported.

In this example, SiteNameLength may comprise a 32-bit integer value that specifies the length of the SiteName string in the referral request. Similarly, SiteName may comprise a null terminated UNICODE string specifying the site identifier, such as the obtained site identifier of the gateway server to which the client device is connected, as discussed above. As discussed, in embodiments, the site name of the site to which that gateway server belongs. In other embodiments, the site identifier may comprise the IP address of the gateway server to which the client device is connected, in which case the packet structure discussed above would be changed to accommodate the IP address of the gateway server in addition to, or instead of, the site name. The length of this string is determined by the value of the SiteNameLength field.

In order to accommodate the referral request contemplated by the present disclosure, the underlying transport protocol may need to be amended. For example, to the extent that SMB2 is used as the underlying transport protocol to support the example REQ_GET_DFS_REFERRAL_EX referral request discussed above, SMB2 may need to be amended as follows. In this example, a new SMB IOCTL is defined called FSCTL_DFS_GET_REFERRALS_EX. The object-referral client program fills the REQ_GET_DFS_REFERRAL_EX message structure, and issues an FSCTL_DFS_GET_REFERRALS_EX IOCTL to SMB2. The payload of the IOCTL is delivered by SMB to the object-referral server (driver), along with the IP address of the client computer (DFS Namespace client that is requesting referrals).

Referring back to FIG. 3, at step 360, ordered object referrals are received. In embodiments, an object-referral client program operating on a remote client device may receive the ordered referrals from an object-referral server in response to the referral request made in step 350. In embodiments, the object referrals may be received in a DFS Referral message, such as a RESP_GET_DFS_REFERRAL message.

The method 300 continues to step 370, where the target object or file is accessed using one or more of the object referrals received at step 360. For example, when the object referral(s) received comprise paths to one or more file replicas on shared storage servers, the client device may issue a request to retrieve such replica(s) using the received object referrals. For example, the client device may attempt to use the first-ordered object referral; and if that fails, use the next-ordered object referral until access to the target object or file is achieved. In embodiments, the client device may, itself, sort, or reorder, the object referrals to decide which object referral to use first to attempt to access the target object or file.

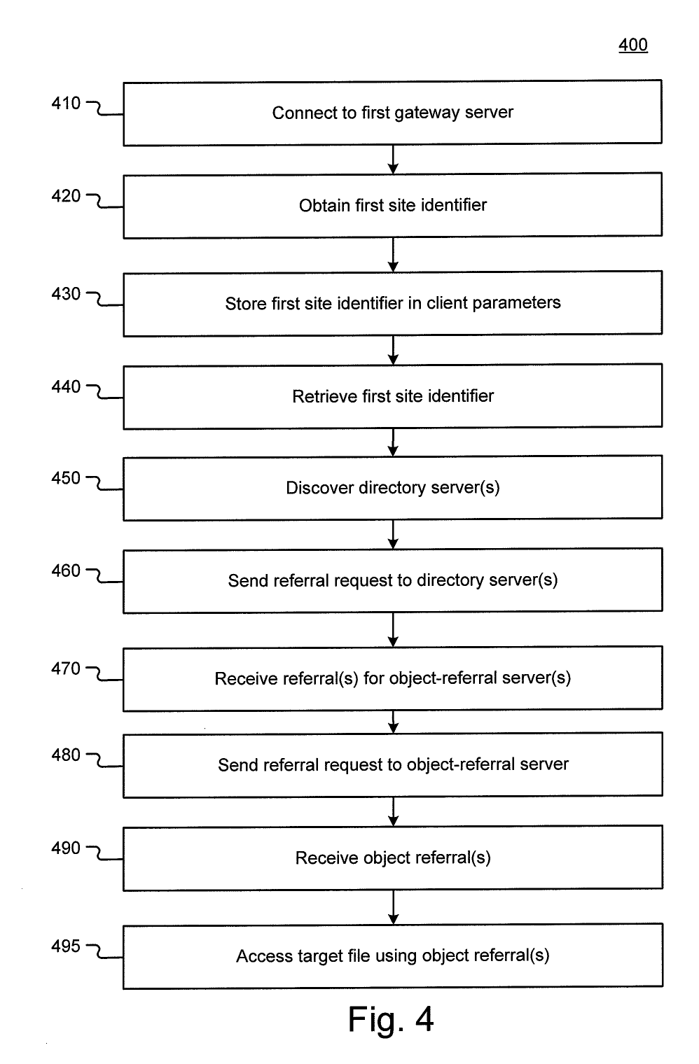

FIG. 4 illustrates an embodiment of a method 400 to obtain least-cost access to a file in a system having multiple directory servers and object-referral servers, such as the example system of FIG. 2. At step 410, a connection is made to a first gateway server, such as gateway server 225 by client device 260. The method 400 proceeds to step 420, at which a first site identifier is obtained. As discussed, the site identifier of the gateway server may be received by the client device as part of the connection process in step 410. In other embodiments, the site identifier of the gateway server may be obtained by retrieving the site identifier from local storage or another accessible storage location. In embodiments, the site identifier comprises the IP address of the gateway server or a site name of the site to which the gateway server belongs. Once the site identifier of the gateway server is obtained 420, the method 400 continues to step 430 at which the site identifier is stored in client parameters of the client device. As discussed, a network access client program operating on the client device may store the site identifier in a client parameter setting, such as a registry key, on the client device.

At step 440, the site identifier is retrieved. As discussed, an object-referral client program operating on the client device may, for example, retrieve the site identifier after receiving notice that the client parameters have changed. At step 450, one or more directory server(s) are discovered. In embodiments, a client device sends a request to a domain name system (DNS) server for a list of directory servers that are appropriate for the namespace of a particular target file. Once the list of directory server(s) is received, flow proceeds to step 460.

At step 460, a referral request is sent to at least one of the directory server(s) identified in step 450. The referral request may include the site identifier retrieved at step 440. In this case, the referral request is a request for referral to object-referral servers appropriate to provide referrals to the target file. At step 470, a list of ordered referrals to object-referral servers is received.

At step 480, a referral request is sent, for example, by the client device through the gateway server, to at least one of the object-referral servers identified in the referrals received at step 470. In embodiments, the client device attempts to send a referral request to the first object-referral server for which a referral is listed in the ordered list of referrals received at step 470. If that request fails, the client device attempts to use the next referral on the list until a referral request is successful.

At step 490, a list of object referrals is received. In embodiments, the list of referrals is ordered according to least-cost of access. In other embodiments, the client device may order the referrals based on information received with the list of referrals or otherwise obtained by the client. At step 495, the target file or object is accessed using the list of referrals received at step 490. For example, a client device may attempt to use the first-ordered object referral; and if that fails, use the next-ordered object referral until access to the target object or file is achieved.

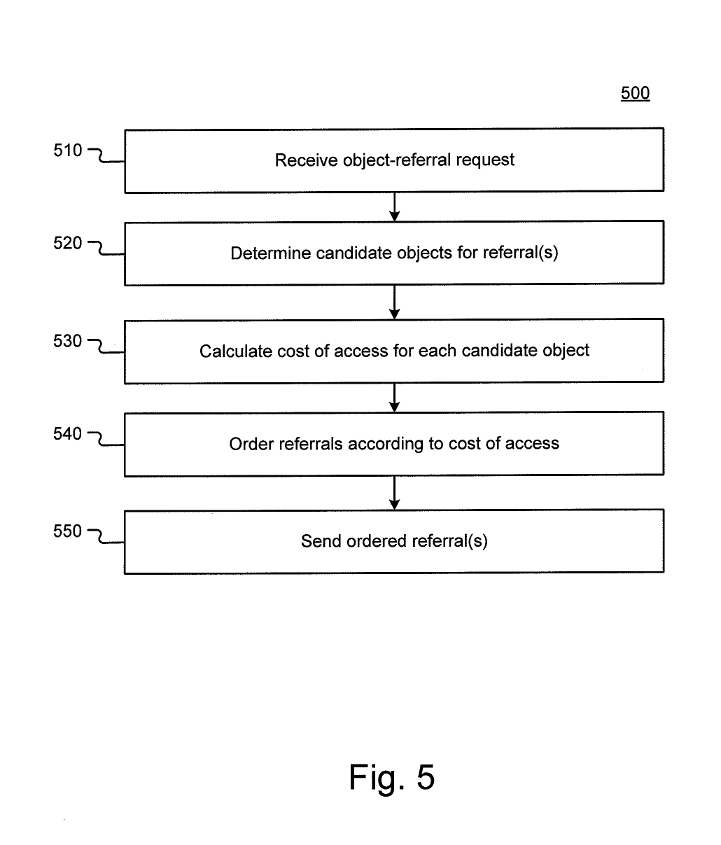

FIG. 5 illustrates an embodiment of a method 500 in which an object-referral server provides ordered object referrals to a client device. In embodiments, the method 500 may be performed by an object-referral server (such as object-referral servers 115, 215, 227, and 247 or directory servers 122, 222, 228, and 248). At step 500, a referral request is received. In embodiments, the referral request includes both a site identifier, identifying the site of the requesting client device, and a target object. In embodiments, the target object may be, among other things, an object-referral server or a file stored on a storage server.

At step 520, candidate objects that meet the criteria for referral are determined. For example, if the object for which referrals are requested comprises a file stored in a distributed file system, replicas of that file are the candidate objects, and the locations of replicas of that file are determined. At step 530, the cost of access to each candidate object is determined. For example, in embodiments, the cost of access is determined based on the geographic distance between the site identified in the site identifier included in the referral request and the storage server storing each candidate object. In other embodiments, more advanced cost determinations are made.

For example, in embodiments the referral request received in step 510 may indicate whether (a) the client device is remotely connected via a gateway server and (b) whether the client device is willing to disconnect from its current gateway server and reconnect to another gateway server. In this embodiment, if the client is willing to reconnect to a different gateway server, the cost calculation for access to each candidate object may take into account the cost of access from a different site than is identified in the referral request.

For example, with reference to the example system of FIG. 1, assume that the target object is a file for which replicas exist in storage servers 107 and 150, but not in storage server 135. Assume also that gateway server 120 is inoperable. When object-referral server 115 receives the referral request from client device 160, the referral request includes a site identifier identifying the client as belonging to site 102 (because the client device received and then used the site identifier provided by gateway 125). Assume also, for this example, that the referral request indicates to object-referral server 115 that the client device 160 is connected remotely and is willing to reconnect through a different gateway server.

The object-referral server 115 identifies two candidate objects, the replicas of the target file that exists on storage servers 107 and 150. If the object-referral server 115 calculates the cost to access each candidate object based on the site of client 160 being site 102, then it will order the referrals to the candidate objects as follows: first the replica on storage servers 107 and second the replica on storage server 150. This is because access from site 102 to storage servers 107 requires only one (relatively expensive) WAN link 105, whereas access to the storage server 150 requires traversal of two WAN links 105 and 104. However, in embodiments, object-referral server 115 may also take into account that the client device 160 has indicated a willingness to reconnect to a different gateway server. Gateway server 120 is inoperable, so the cost of accessing the replica on storage servers 107 would still involve traversal of WAN link 105. Access to the replica on storage server 150, however, may be accomplished by disconnecting client device 160 from gateway server 125 and reconnecting to gateway server 140. The public network connection from client device 160 to gateway server 140 may, in fact, be considerably less costly than the WAN link 105. Accordingly, even if storage server 150 may be geographically farther from site 102 than storage server 107, object-referral server 115 may calculate a lower “cost” to access the replica on storage server 150 than the replica on storage servers 107.

In embodiments, the calculation of cost of candidate objects can take many forms and is informed with information regarding the relative cost of WAN links (or other privately leased lines) versus the use of public networks or other communication lines to connect remote clients to different gateway servers. In addition, in this embodiment, the object-referral server has access to a list of available gateway servers and the sites in which they are located.

Referring again to FIG. 5, the requested referrals to candidate objects are ordered at step 540. In embodiments, the referrals are ordered in ascending order of cost to access. Other ordering protocols may be employed. At step 550, the ordered referrals are sent, for example to the requesting client device. In embodiments, referrals may be ordered based on a simple cost calculation for candidate objects (e.g., geographic distance of the candidate object from the site identified in the referral request). In other embodiments, the referrals may be ordered based on a calculation that includes an assumption that the client device will reconnect to a different gateway server. In the latter case, the ordered referrals may also include instructions or addresses of one or more alternative gateway server(s) to which connection can or should be made to achieve least-cost access to a target object. For example, each ordered referral may identify both a gateway server to which the client device should connect and the path to the requested object.

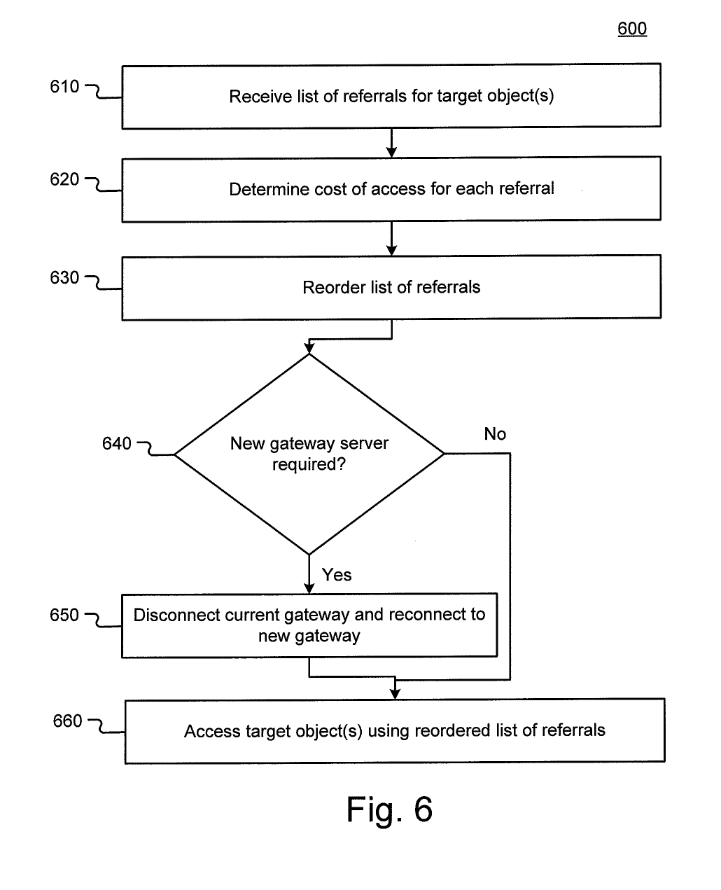

FIG. 6 describes a method 600 in which least-cost access is determined for a given set of object referrals. For example, a client device may receive a list of referrals for a target object and may, itself, calculate (or recalculate) the cost of access using each of those referrals. In embodiments, at step 610, a list of referrals for a target object is received. The list may be received, for example, in response to a request for referrals to an object-referral server. In embodiments, the list may or may not have been ordered according to a cost calculation by the object-referral server. For example, if the referral request includes an explicit declaration of the client device's site (based on a site identifier received from the gateway server to which the client device is connected), the object-referral server may order referrals based on the cost to access candidate objects from the identified site. In embodiments, the object-referral server may be unable to make more sophisticated cost calculations for referrals to candidate objects. In embodiments, the client device may order or reorder the referrals based on its own cost calculations.

At step 620, a cost of access for each referral to a target object is calculated. In embodiments, the client device is programmed to make this calculation itself. In other embodiments, the client device may request that another device or service perform such calculation. As discussed in relation to FIG. 5, the cost calculation may include the contingency that the client device is able (and willing) to disconnect from its current gateway server and reconnect to a different gateway server at another site. As such, the cost calculation may include the cost of accessing a target object from the closest gateway server to that target object. For example, as discussed in relation to step 530 in method 500, the cost calculation may take into account that a public-network connection (e.g., an Internet connection) to a geographically distant gateway server that is in the same site as a referred target object may be less costly than a connection to a geographically close gateway server that is connected by WAN links or other privately leased communication lines to a storage server housing a target object.

In embodiments, the calculation of cost is facilitated by information received by the client device regarding (a) the available gateway servers, (b) the sites to which those gateway servers belong (and the locations of those sites), the relative cost(s) of any privately leased communication links used in an enterprise network versus a public network used to connect the client device to the gateway server(s), and the site(s) in which the referred target objects are stored. Some or all of this information may be provided to the client device by the object-referral server along with the object referrals or by one or more different network devices.

At step 630, the list of referrals is ordered (or reordered) according to the cost calculations of step 620. At step 640, a determination is made whether a referral to be used requires that the client device disconnect from its current gateway server and reconnect to a different server. If not, flow proceeds to step 660. If so, at step 650, the client device is disconnected from its current gateway server and reconnected to the gateway server required for the object referral to be used. At step 660, the object referral is used to access the target object as previously discussed.

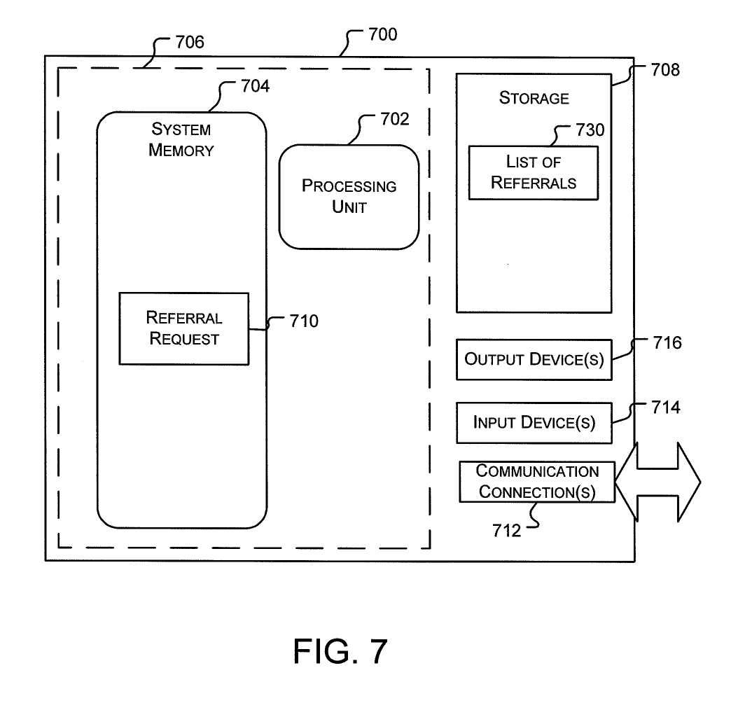

FIG. 7 illustrates a general computing device 700 (also referred to herein as a device, computer or computer system), which can be used to implement the embodiments described herein. The computing device 700 is only one example of a computing environment and is not intended to suggest any limitation as to the scope of use or functionality of the computer and network architectures. Neither should the computing device 700 be interpreted as having any dependency or requirement relating to any one or combination of components illustrated in the example computing device 700. In embodiments, computing device 700 may be used, for example, as a client device 160 and 260, object-referral server 115, 215, 227 and 247, directory server 122, 222, 228 and 248, storage servers 107, 207, 135, 235, 150, and 250, and gateway servers 120, 220, 125, 225, 140, and 240 as described above with respect to FIG. 1.

In its most basic configuration, computing device 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. System memory 704 stores applications that are executing on computing device 700. In addition to applications, memory 704 may also store information being used in operations being performed by computing device 700, such as a referral request 710, as described with respect to FIGS. 1-6.

Additionally, computing device 700 may also have additional features/functionality. For example, computing device 700 may also include additional storage 708 (removable and/or non-removable) including, but not limited to, magnetic or optical disks or tape. Such additional storage is illustrated in FIG. 7 by storage 708. Computer storage media includes volatile and nonvolatile, removable and non-removable media implemented in any method or technology for storage of information such as computer readable instructions, data structures, program modules or other data. Memory 704 and storage 708 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 700. Any such computer storage media may be part of computing device 700. As those with skill in the art will appreciate, storage 708 may store a variety of information. Among other types of information, storage 708 may store a list of referrals 730.

Computing device 700 may also contain communications connection(s) 712 that allow the system to communicate with other devices. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Computing device 700 may also have input device(s) 714 such as keyboard, mouse, pen, voice input device, touch input device, etc. Output device(s) 716 such as a display, speakers, printer, etc. may also be included.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternative embodiments having fewer than or more than all of the features herein described are possible.

While various embodiments have been described for purposes of this disclosure, various changes and modifications may be made which are well within the scope of the present disclosure. Numerous other changes may be made which will readily suggest themselves to those skilled in the art and which are encompassed in the spirit of the disclosure and as defined in the appended claims.

We claim:

1. A computer-implemented method for obtaining least-cost access to an object, comprising:
connecting, by a client device, to a first gateway server of an enterprise network, wherein the client device is remote from the enterprise network;
obtaining, by the client device, a first site identifier that identifies a first site for the first gateway server;
sending, by the client device, to an object-referral server a first referral request for first one or more referrals to an object, wherein the first referral request includes the first site identifier;
receiving, by the client device, the first one or more referrals to the object, wherein the first one or more referrals are ordered;
using the first one or more referrals to access the object.

2. The computer-implemented method of claim 1, wherein the object is replicated and stored in a plurality of storage servers in the enterprise network and the first one or more referrals each comprise a path to one of the plurality of storage servers.

3. The computer-implemented method of claim 2, wherein the first one or more referrals are ordered by geographic distance between the first site of the first gateway server and a closest one of the plurality of storage servers.

4. The computer-implemented method of claim 1, wherein the first referral request is routed through the first gateway server.

5. The computer-implemented method of claim 1, further comprising:
disconnecting the client device from the first gateway server and connect to a second gateway server; and
connecting to the second gateway server;
wherein using the first one or more referrals to access the object comprises requesting access to the object through the second gateway.

6. The computer-implemented method of claim 1, wherein the second gateway server is located at a second site and the first one or more referrals are ordered by geographic distance between the second site of the second gateway server and a closest one of the plurality of storage servers.

7. The computer-implemented method of claim 1, wherein the first site identifier comprises a resolved site name.

8. The computer-implemented method of claim 1, wherein the first site identifier comprises an IP address of the first gateway server.

9. The computer-implemented method of claim 1, further comprising:
disconnecting the client device from the first gateway server;
connecting the client device to a second gateway server;
obtaining by the client device, a second site identifier that identifies a second site for the second gateway server;
sending, by the client device, to the object-referral server a second referral request for second one or more referrals to the object, wherein the second referral request includes the second site identifier;
receiving, by the client device, the second one or more referrals to the object, wherein the second one or more referrals are ordered differently from the first one or more referrals;
using the second one or more referrals to access the object.

10. The computer-implemented method of claim 1, wherein the object comprises at least one of a file, a service, an application, a namespace server, or a web site.

11. The computer-implemented method of claim 1, further comprising generating the first referral request, wherein generating the first referral request includes:
storing the first site identifier in a parameter setting for the first client device;
retrieving the first site identifier from the parameter setting; and
inserting the first site identifier into the first referral request.

12. A system for obtaining least-cost access to an object, comprising:
at least one processing unit;
a memory, operatively connected to the at least one processing unit and containing instructions that, when executed by the at least one processing unit, cause the at least one processing unit to perform a method, the method comprising the steps of:
connecting, by a client device, to a first gateway server of an enterprise network, wherein the client device is remote from the enterprise network;
obtaining, by the client device, a first site identifier that identifies a first site for the first gateway server;
sending, by the client device, to an object-referral server a first referral request for first one or more referrals to an object, wherein the first referral request includes the first site identifier;
receiving, by the client device, the first one or more referrals to the object, wherein the first one or more referrals are ordered;
using the first one or more referrals to access the object.

13. The system of claim 12, wherein the object is replicated and stored in a plurality of storage servers in the enterprise network and the first one or more referrals each comprise a path to one of the plurality of storage servers.

14. The system of claim 12, wherein the method further comprises:
disconnecting the client device from the first gateway server and connecting to a second gateway server; and
connecting to the second gateway server;
wherein using the first one or more referrals to access the object comprises requesting access to the object through the second gateway.

15. The system of claim 14, wherein the second gateway server is located at a second site and the first one or more referrals are ordered by geographic distance between the second site of the second gateway server and a closest one of the plurality of storage servers.

16. The system of claim 12, wherein the method further comprises:
disconnecting the client device from the first gateway server;
connecting the client device to a second gateway server;
obtaining by the client device, a second site identifier that identifies a second site for the second gateway server;
sending, by the client device, to the object-referral server a second referral request for second one or more referrals to the object, wherein the second referral request includes the second site identifier;
receiving, by the client device, the second one or more referrals to the object, wherein the second one or more referrals are ordered differently from the first one or more referrals;
using the second one or more referrals to access the object.

17. The computer-implemented method of claim 1, further comprising generating the first referral request, wherein generating the first referral request includes:
storing the first site identifier in a parameter setting for the first client device;
retrieving the first site identifier from the parameter setting; and
inserting the first site identifier into the first referral request.

18. A system for providing least-cost access to an object by a remote client device, the system comprising:
a first gateway server located at a first site and configured to provide access for the remote client device to an enterprise network;
an object-referral server, operatively connected to the first gateway server and configured to provide ordered referrals to a first object that is replicated and stored in a plurality of storage servers on the enterprise network;
the plurality of storage servers, operatively connected to the first gateway server and configured to store the replicated first object;
wherein the first gateway server is configured to connect to a remote client device;
wherein the object-referral server is configured to:
receive from the first remote client a first referral request for first one or more referrals to the first replicated object, wherein the first referral request includes a first site identifier for the first gateway server;
perform a least-cost-access calculation from the first site to one or more of the plurality of storage servers;
order the one or more referrals based on the calculation; and
provide the one or more referrals to the remote client device.

19. The system of claim 18, wherein the first referral request is received from the remote client through the first gateway server.

20. The system of claim 18, wherein the object-referral server is further configured, in performing the least-cost-access calculation, to determine for at least one of the referrals, the cost of access from a second gateway server to the first object.
